(19) United States
(12) Patent Application Publication
(10) Pub. No.: US 2025/0383520 A1
(43) Pub. Date: Dec. 18, 2025

(54) THERMALLY-RESPONSIVE ACTUATOR ASSEMBLY AND CORRESPONDING THERMALLY-COMPENSATED OPTICAL SYSTEM

(71) Applicant: RAFAEL ADVANCED DEFENSE SYSTEMS LTD., Haifa (IL)

(72) Inventors: Dror RAF, Kefar Tavor (IL); Oded LAHAV, Atzmon (IL)

(21) Appl. No.: 19/144,550

(22) PCT Filed: Oct. 11, 2023
(86) PCT No.: PCT/IB2023/060220

§ 371 Date: Jun. 30, 2025

(30) Foreign Application Priority Data
Dec. 29, 2022 (IL) 299589

(51) Int. Cl. G02B 7/00; G02B 7/02

(52) U.S. Cl. CPC G02B 7/008; G02B 7/028

(57) ABSTRACT

A thermally-compensated optical system (30) has a thermally-responsive actuator assembly (38) between first and second optical components (32,34) arrayed along an optical axis. The actuator assembly has actuators (10) integrated into a collar encircling the optical axis. Each actuator has two interconnected beams (12a,12b) from a first 5 material and a rod (18) associated with the ends of both beams such that a distance between the ends is determined by a length of the rod. The rod is formed from a second material having a coefficient of thermal expansion different from that of the first material such that a variation in temperature causes deformation of the actuators, thereby varying a height of the actuators according to an effective coefficient of thermal expansion with 10 a magnitude greater than that of both materials. This adjusts a relative position of the first and second components along the optical axis.

### FIELD AND BACKGROUND OF THE INVENTION

The present invention relates to optical systems and, in particular, it concerns a thermally-responsive actuator assembly and corresponding thermally-compensated optical systems.

Optical systems are known to be sensitive to temperature variations. Particularly in the case of high-performance systems, such as with large apertures and/or high magnification, relative positioning of the components of the optical system is highly sensitive, and expansion or contraction of the components due to changes in temperature may significantly impact image quality. This issue is particularly pronounced in relation to systems for mounting on airborne platforms, where the system may need to operate over a range of temperatures in excess of 60 degrees Celsius.

### SUMMARY OF THE INVENTION

The present invention is a thermally-responsive actuator assembly and corresponding thermally-compensated optical systems.

According to the teachings of an embodiment of the present invention there is provided, a thermally-compensated optical system comprising: (a) first and second components aligned sequentially along an optical axis of the system; and (b) a thermally-responsive actuator assembly comprising a plurality of actuators integrated into a collar at least partially encircling the optical axis interposed between, and mechanically linked to, the first component and the second component, wherein each of the actuators comprises: (i) first and second beams each having a first end, a second end and a length, the first ends of the first and second beams being flexibly interconnected such that the lengths of the first and second beams form between them an obtuse angle, the first and second beams being formed from a first material having a first coefficient of thermal expansion, and (ii) a rod associated with the second ends of the first and second beams such that a distance between the second ends is determined by a length of the rod, the rod being formed from a second material having a second coefficient of thermal expansion, the actuators having a height in a direction perpendicular to the length of the rod, the first and second coefficients of thermal expansion differing such that variation in temperature causes deformation of the actuators, thereby varying the height of the actuators according to an effective coefficient of thermal expansion with a magnitude greater than both the first and the second coefficients of thermal expansion, a variation in the height causing a corresponding variation in relative position of the first and second components along the optical axis.

According to a further feature of an embodiment of the present invention, each of the actuators further comprises third and fourth beams formed from the first material and each having a first end, a second end and a length, the first ends of the third and fourth beams being flexibly interconnected such that the lengths of the third and fourth beams form between them an obtuse angle, the second ends of the third and fourth beams being interconnected with the second ends of the first and second beams, respectively, such that the first, second, third and fourth beams form a rhombus.

According to a further feature of an embodiment of the present invention, the first material extends continuously around the collar, and wherein the first, second, third and fourth arms of each of the actuators are integrally formed as bifurcations of the collar.

According to a further feature of an embodiment of the present invention, the rods are inserted within apertures formed by the bifurcations.

According to a further feature of an embodiment of the present invention, over an operating range of temperatures including room temperature, each of the rods is oversized for the aperture, such that the actuator is pre-stressed.

According to a further feature of an embodiment of the present invention, the thermally-responsive actuator assembly comprises three of the actuators spaced around the collar.

According to a further feature of an embodiment of the present invention, the first ends of the beams are flexibly interconnected via an attachment configuration configured for attaching the actuator assembly to one of the first and second optical components.

According to a further feature of an embodiment of the present invention, the attachment configuration of each of the actuators is located further from the optical axis than a straight line extending between the second ends of the first and second beams and closer to the optical axis than the second ends of the first and second beams.

According to a further feature of an embodiment of the present invention, the beams are flexibly interconnected via at least one integral hinge, the integral hinge being oriented to define an effective hinge axis lying in a plane substantially perpendicular to the optical axis.

According to a further feature of an embodiment of the present invention, the second coefficient of thermal expansion is greater than the first coefficient of thermal expansion, so that the effective coefficient of thermal expansion of the thermally-responsive actuator is negative.

### BRIEF DESCRIPTION OF THE DRAWINGS

The invention is herein described, by way of example only, with reference to the accompanying drawings, wherein:

FIGS. 1A and 1B are schematic diagrams illustrating a principle of operation of a thermally-responsive actuator according to the teachings of an embodiment of the present invention, shown in a one-sided (“triangular”) and a two-sided (“rhombus”) implementation, respectively;

FIG. 2 is a schematic isometric view of a thermally-compensated optical system, constructed and operative according to an embodiment of the teachings of the present invention, employing a thermally-responsive actuator assembly;

FIG. 3 is a side view of the thermally-compensated optical system of FIG. 2;

FIG. 4 is a cross-sectional view taken along the line IV-IV in FIG. 3;

FIG. 5 is an isometric view of the thermally-responsive actuator assembly of FIG. 2;

FIG. 6 is an exploded isometric view of the thermally-responsive actuator of FIG. 5;

FIGS. 7A-7C are views similar to FIG. 5 showing the thermally-responsive actuator in a contracted, intermediate and expanded state, respectively, where the displacements have been exaggerated for clarity of presentation;

FIG. 8A is a schematic plan view of the thermally-responsive actuator assembly of FIG. 2 according to a triangular collar implementation; and

FIG. 8B is a schematic plan view of the thermally-responsive actuator assembly of FIG. 2 according to a modified-triangular collar implementation.

### DESCRIPTION OF THE PREFERRED EMBODIMENTS

The present invention is a thermally-responsive actuator assembly and corresponding thermally-compensated optical systems.

The principles and operation of a thermally-responsive actuator assembly and corresponding thermally-compensated optical systems according to the present invention may be better understood with reference to the drawings and the accompanying description.

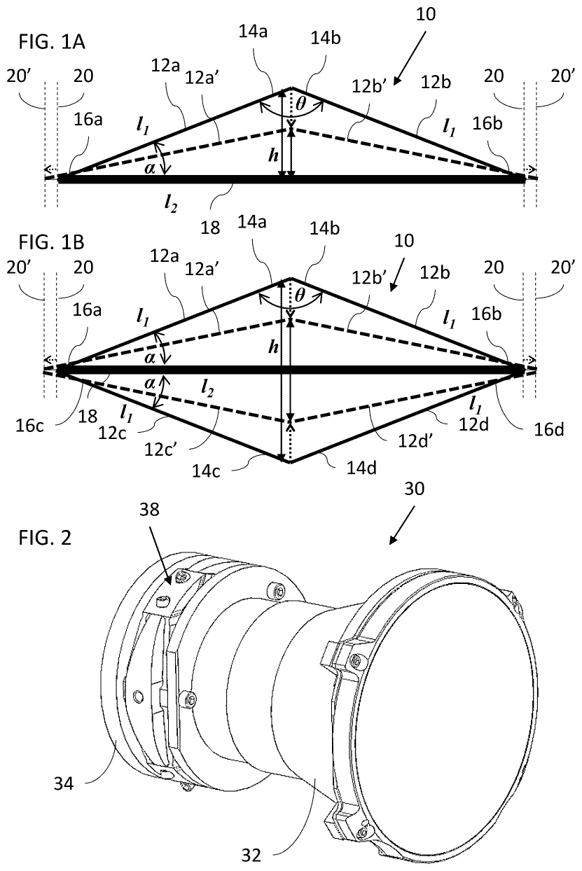

Referring now to the drawings, FIGS. 1A and 1B are schematic illustrations of an operating principle of a thermally-responsive actuator employed by preferred embodiments of the present invention. Specifically, FIG. 1A illustrates an actuator, generally designated 10, constructed and operative according to an embodiment of the present invention, which includes first and second beams 12a, 12b each having a first end 14a, 14b, a second end 16a, 16b and a length l₁. First ends 14a, 14b of the first and second beams 12a, 12b are flexibly interconnected such that the lengths of the first and second beams form between them an obtuse angle θ. First and second beams 12a, 12b are formed from a first material having a first coefficient of thermal expansion CTE₁.

A rod 18 is associated with the second ends 16a, 16b of the first and second beams 12a, 12b such that a distance between the second ends is determined by a length l₂ of the rod. Rod 18 is formed from a second material having a second coefficient of thermal expansion CTE₂. Actuator has a height h measured in a direction perpendicular to the length of rod 18, i.e., corresponding to the height of an isosceles triangle formed by first and second beams 12a, 12b with rod 18 as the base.

The first and second materials are chosen such that the first and second coefficients of thermal expansion differ. As a result, a variation in temperature causes deformation of the actuators, thereby varying the height of the actuators according to an effective coefficient of thermal expansion CTE_{eff} with a magnitude greater than both the first and the second coefficients of thermal expansion. This is illustrated graphically in FIG. 1A by dashed arrows. Specifically, if rod 18 expands relative to first and second beams 12a, 12b from an initial length indicated by lines 20 to an increased length indicated by lines 20′, the isosceles triangle formed by first and second beams 12a, 12b will deform as illustrated by dashed lines for first and second beams 12a′, 12b′.

The above non-limiting description refers to a case in which rod 18 expands relative to first and second beams 12a, 12b, corresponding to a case where CTE₂ is larger than CTE₁. In this case, an increase in temperature results in a reduction in the height h of the actuator, giving rise to a negative effective coefficient of thermal expansion. This case is particularly useful for a typical scenario in which the actuator is compensating for other components which tend to expand under conditions of increased temperature. However, in certain implementations, it may be desirable to provide actuators with a positive but amplified effective coefficient of thermal expansion. In this case, CTE₁ is chosen to be greater than CTE₂, and the illustrated reduction in height would then occur in a scenario of cooling, where the lengths of first and second beams 12a, 12b decrease more significantly than that of rod 18. In both cases, the motion is preferably bidirectional and fully reversible under an opposite variation in temperature.

The magnitude of the displacement for a given temperature change and the effective coefficient of thermal expansion can be derived by trigonometry. Considering the right-angled triangle formed by first beam 12a, half of rod 18 and the height h in FIG. 1A, the angle α is determined by arccosine of the ratio of half of l₂ to l₁, while the height h is determined by the product of lᵢ and the sine of angle α. The changes of dimensions of first beam 12a and rod 18 thus lead directly to a corresponding change in the angle α and hence of the height h. Where the design does not exactly fit this triangular model, depending for example on the location of integral hinges that define flexion locations, as exemplified below, the geometrical model can be modified accordingly, or a design with the appropriate effective CTE can readily be derived empirically through a relatively small number of trials.

FIG. 1B illustrates an alternative implementation of the actuator of FIG. 1A in which first and second beams 12a, 12b are supplemented by third and fourth beams 12c, 12d formed from the first material which together form a rhombus. Here too, the first ends 14c, 14d of the third and fourth beams 12c, 12d are flexibly interconnected such that the lengths of the first and second beams form between them an obtuse angle θ. The second ends 16c, 16d of the third and fourth beams 12c, 12d are interconnected with the second ends 16a, 16b of the first and second beams 12a, 12b, respectively, thereby forming a rhombus.

Operation of the actuator of FIG. 1B is identical to that of FIG. 1A except that the geometrical changes and resulting change in height are doubled, occurring both above and below rod 18, with beams 12a, 12b, 12c, 12d being deflected to positions 12a′, 12b′, 12c′, 12d′, or the reverse, according to the relative values of CTE₁ and CTE₂ and the direction of temperature change. Due to the enhanced magnitude of displacement, this double-sided actuator is preferred as the basis for the non-limiting example illustrated in the remainder of this document. It should be noted, however, that a single-sided actuator is also of utility, and may be used to advantage in scenarios in which relatively smaller displacements are required.

The form of the actuators of FIGS. 1A and 1B are described herein according to their functional form as an isosceles triangle and a rhombus, respectively. These labels reflect the underlying geometry which, together with the differential in CTE between the materials, gives rise to a thermally-induced motion of the actuator. However, as will become clear from the description below, the shape of the actuators in a practical implementation may vary considerably from ideal planar polygons, including, for example, rounded corners, flattened attachment regions, curvature or angles that render the geometrical form three-dimensional, and integral hinges which localize and define the flex-direction of regions of flexion. Additionally, full rhombic symmetry is not required, such that a kite shape is also considered herein to embody the broadly-defined rhombus form. Similarly, isosceles symmetry is also not strictly required. If the first and second beams are unequal in length, the actuator will still operate, but the motion will be accompanied by a component of translation. In certain applications, such translation may be permissible, or may be canceled out by the use of multiple asymmetric actuators.

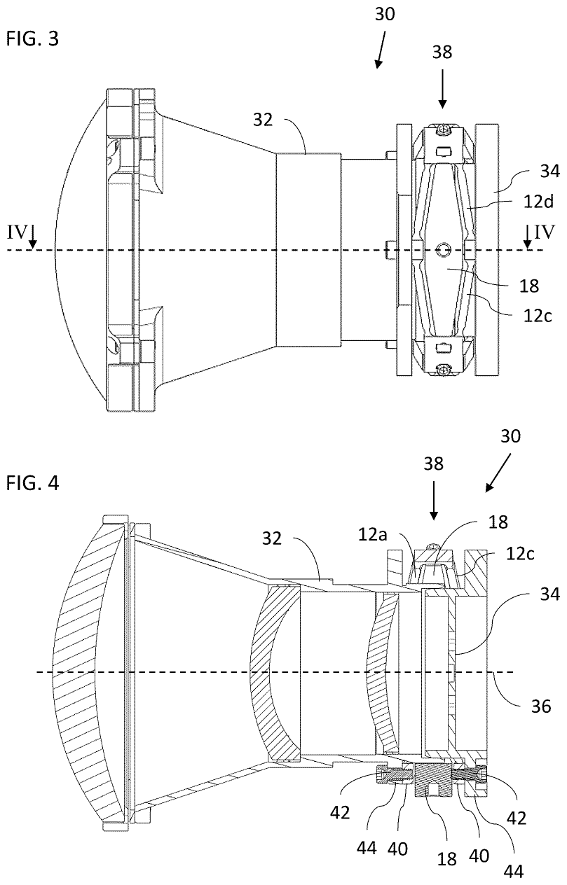

Turning now to FIGS. 2-4, there is shown a thermally-compensated optical system, generally designated 30, that includes first and second components 32, 34 aligned sequentially along an optical axis 36 (visible in FIG. 4) of the system. Components 32 and 34 maybe any components of an optical system for which compensation for thermal expansion or contraction is advantageous, including but not limited to, components of a telescope, components of a microscope, or components of a projector. In the non-limiting example illustrated here, first component 32 is a lens assembly including a plurality of lens elements in a tubular housing forming a telescope, while second component 34 is a support for a focal plane sensor array, such as a CCD, CMOS image sensor or infrared sensor array. If first and second components 32 and 34 were directly attached to each other with the sensor array correctly positioned in the focal plane at a certain temperature, variations in temperature would cause expansion (elongation) or contraction (shortening) of the lens assembly 32, resulting in the image being brought to focus slightly above or below the sensor array, with a consequent reduction in image quality.

To address this issue, it is a particular feature of certain preferred embodiments of the present invention that the optical system employs a thermally-responsive actuator assembly 38 comprising a plurality of actuators 10 integrated into a collar at least partially encircling optical axis 36, interposed between, and mechanically linked to, first component 32 and second component 34.

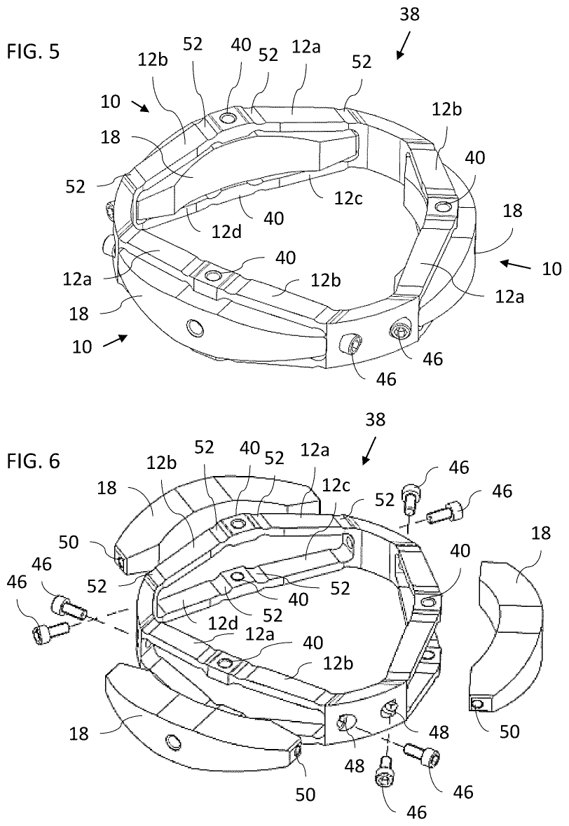

Thermally-responsive actuator assembly 38 is best seen in FIGS. 5 and 6. Thermally-responsive actuator assembly 38, in the particularly preferred implementation illustrated here, combines three actuators 10, each essentially similar to the actuator illustrated schematically above in FIG. 1B, with four beams 12a-12d forming a closed geometrical form approximating to a rhombus and a rod 18 inserted in the long diagonal of the rhombus.

The actuators 10 are arranged around the collar such that their “height” is aligned parallel to the optical axis. The first ends of the beams are shown here flexibly interconnected via an attachment configuration 40 configured for attaching the actuator assembly to one of the first and second optical components. In this implementation, attachment configuration 40 is a threaded hole into which a threaded bolt 42 (FIG. 4) engages to clamp flanges 44 of the first and second components 32 and 34 to the actuator assembly 38. Thus, simultaneous variation of the height of the actuators due to a change in temperature causes a symmetrical adjustment in the spacing of flanges 44. In a typical but non-limiting example, the rod 18 is formed from material with a relatively high CTE, such as aluminum (23.6 μm/m.° C.) while the beams 12a-12d are formed from a material with a lower CTE, such as titanium (8.6 μm/m.° C.). This results in a negative effective CTE, such that the actuator assembly decreases its height on heating and increases its height on cooling. As a result, the thermally-responsive actuator assembly can be used to compensate for thermal variations in the dimensions of the first and second components 32 and 34, thereby maintaining accurate focus of the optical system over a wide range of operating temperatures.

The collar form-factor of the actuator assembly is particularly convenient in the scenario of optical components alignment sequentially along an optical axis, since it allows deployment of the actuator assembly for assembly around the optical axis without obstructing the optical axis, and without needing to separately assemble and align multiple separate actuators. While a pair of actuators, or even a single actuator, could provide the required relative motion for thermal compensation, in order to provide an inherently stable mechanical connection without necessarily requiring additional bearing arrangements or the like, it is preferable to provide at least three actuators angularly spaced around the collar. In order to achieve a given amplitude of displacement in a minimum volume, each actuator should be as large as possible. For this reason, the use of exactly three actuators, as shown, is typically considered optimal.

The collar may be an open “C-ring” collar with an opening at some location around the periphery. In most cases, a closed collar extending continuously around the optical axis is preferred, due to its structural strength and stability.

Structurally, the first material most preferably extends continuously around the collar, such that all parts of the actuator assembly that are formed from the first material are integrally formed as a unitary collar, with beams of each of the actuators implemented as bifurcations of the collar. Depending on the choice of materials and the corresponding available manufacturing techniques, this unitary collar may be formed by any suitable manufacturing process, such as, for example, by a machining process or by additive manufacturing techniques, or any combination thereof. Rods 18 are then inserted within apertures formed by these bifurcations, to form the complete actuator structures, as seen in FIG. 5.

Most preferably, over an operating range of temperatures including room temperature, each of the rods 18 is oversized for the aperture of the actuator, meaning that, if the unitary collar is placed alongside rods 18, the height of the actuator beams will exceed the maximum height to be achieved during use, and the length of the rod will be too long to fit into the interior of the actuator. Assembly of the actuator can be performed by applying mechanical compression to the ring in the height direction so as to reduce the height and expand the length of the apertures so as to allow insertion of the rods. Alternatively, the rods 18 may be cooled to a low temperature, outside the normal operating range of temperatures, so that they contract in length sufficiently to be inserted into the actuator apertures. The use of oversized rods generates a pre-stressed state of the actuators, and may allow the rods to be retained in position primarily by being trapped under compression within the apertures. Nevertheless, to avoid accidental displacement of the rods from their intended positions, rods 18 are preferably retained in position by retaining bolts 46 which extend through bolt apertures 48 in the ring and engage complementary threaded openings 50 in the ends of rods 18. The pre-stressing of the actuator structures preferably ensures that the retaining bolts do not need to transfer significant force between the rods and the beams.

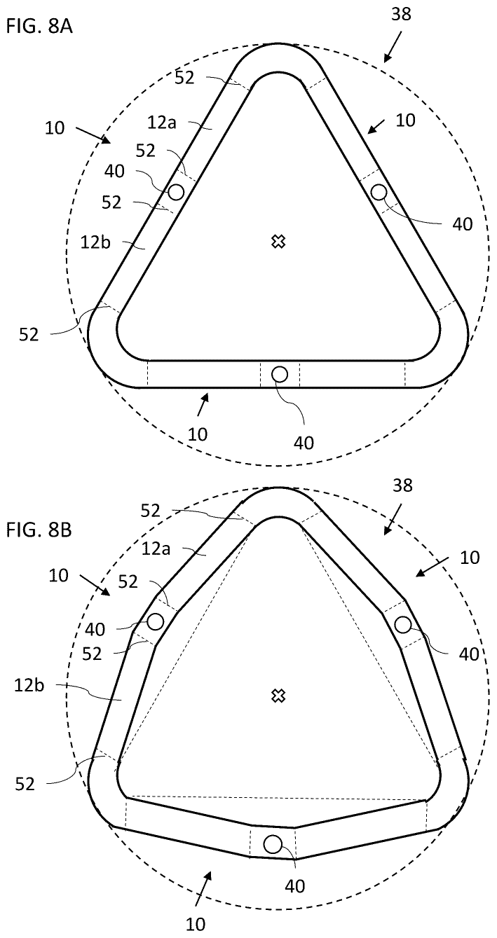

Since the desired displacement of the actuator assembly is parallel to the optical axis, a straightforward implementation of a three-actuator configuration would be roughly triangular in axial (plan) view, as illustrated schematically in FIG. 8A. However, for a given size of internal optical aperture, this shape would be relatively bulky.

An alternative, particularly preferred implementation is illustrated in FIG. 8B, where the attachment configuration 40 (and the first ends 14a-14d of the beams) of each of the actuators is located further from the optical axis than a straight line extending between the second ends of the first and second beams, but closer to the optical axis than the second ends of the first and second beams. In other words, compared to the triangular form of FIG. 8A, the middle portion of each actuator is placed further from the center of the structure, which corresponds to the optical axis 36 of the optical system. This accommodates a larger optical aperture of the device for given external dimensions of the actuator assembly.

The outward positioning of the attachment configuration preferably does not exceed a deflection of more than 30 degrees along the length of the actuator, and more preferably no more than 20 degrees. In other words, whereas a straight actuator would subtend an angle of 180 degree (a straight line) at the middle, the deflected actuator preferably subtends an angle of at least 150 degrees, and more preferably at least 160 degrees. As a result, the attachment configuration 40 lies closer to the optical axis than the regions of second ends 16a-16d, i.e., the attachment configurations are spaced inwardly from the circumscribed circle illustrated in FIG. 8B.

Similarly, rods 18 are preferably implemented as a sort of banana shape, i.e., with a convex curvature or otherwise-shaped cavity on one side and a convex curvature on the other, as exemplified in FIG. 6, in order to provide sufficient rigidity while avoiding inward overhang from the actuators.

Despite the outward deflection of the actuator structures, the desired motion of the actuator remains solely an axial displacement. In order to ensure that the displacement occurs in the desired direction, interconnection of the beams 12a-12d is preferably implemented via integral hinges 52 that are each oriented to define an effective hinge axis lying in a plane substantially perpendicular to the optical axis. The integral hinges thus define the permitted direction of flexion, confining expansion and contraction of the height of the actuator to the axial (height) direction.

Additionally, in order to provide enhanced transverse rigidity and thereby prevent any flexion in the radial direction, beams 12a-12d preferably have a rectangular cross-section where the dimension parallel to the axes of the integral hinges 52 is at least twice the thickness of the beams in a direction parallel to the optical axis.

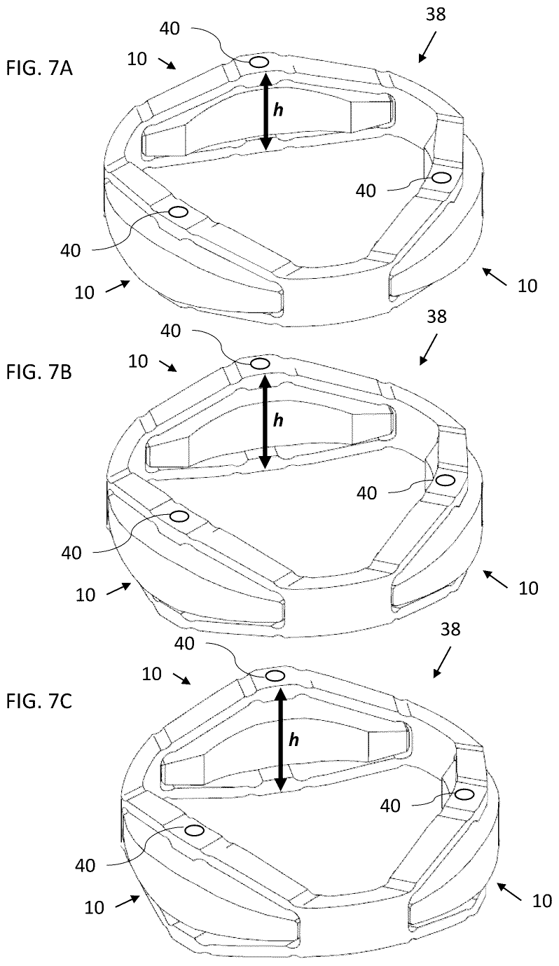

The operation of the thermally-responsive actuator assembly is illustrated schematically in FIGS. 7A-7C. In the typical case in which rod 18 is formed from a relatively-high CTE material (e.g., aluminum) and the surrounding frame is formed from a relatively-low CTE material (e.g., titanium), the state of FIG. 7A corresponds to a relatively high-temperature state in which the rod is expanded relative to the frame, causing extension of the in-plane diagonal of each actuator and reducing the height h to a minimum. When the temperature drops, the rod shrinks more than the frame, reducing in-plane strain on the beams of each actuator and allowing the actuators to return elastically to their increased-height configuration, as illustrated in FIGS. 7B (intermediate state) and 7C (maximum-height state).

If the materials are reversed so that the frame is formed from a material with a higher CTE than the rods, the temperature dependence is reversed, so that the state of FIG. 7A becomes the lowest-temperature state and FIGS. 7B and 7C represent deformations for successively increased temperatures.

It should be noted that the displacements here are shown greatly exaggerated, and that over a typical range of working temperatures spanning tens of degrees Celsius, the variations in dimensions and in the resulting geometry of the actuators are often sufficiently small that they are not readily noticeable to the eye. As a result, the effective coefficient of thermal expansion CTE_{eff} is typically constant over the range of operating temperatures, resulting in a linear variation of displacement with variations in temperature over the operating range of temperatures.

It will be appreciated that the above descriptions are intended only to serve as examples, and that many other embodiments are possible within the scope of the present invention as defined in the appended claims.

What is claimed is:

1. A thermally-compensated optical system comprising:
(a) first and second components aligned sequentially along an optical axis of the system; and
(b) a thermally-responsive actuator assembly comprising a plurality of actuators integrated into a collar at least partially encircling the optical axis interposed between, and mechanically linked to, said first component and said second component, wherein each of said actuators comprises:
(i) first and second beams each having a first end, a second end and a length, said first ends of said first and second beams being flexibly interconnected such that the lengths of said first and second beams form between them an obtuse angle, said first and second beams being formed from a first material having a first coefficient of thermal expansion, and
(ii) a rod associated with said second ends of said first and second beams such that a distance between said second ends is determined by a length of said rod, said rod being formed from a second material having a second coefficient of thermal expansion,
said actuators having a height in a direction perpendicular to the length of said rod, said first and second coefficients of thermal expansion differing such that variation in temperature causes deformation of said actuators, thereby varying the height of said actuators according to an effective coefficient of thermal expansion with a magnitude greater than both said first and said second coefficients of thermal expansion, a variation in said height causing a corresponding variation in relative position of said first and second components along the optical axis.

2. The optical system of claim 1, wherein each of said actuators further comprises third and fourth beams formed from the first material and each having a first end, a second end and a length, said first ends of said third and fourth beams being flexibly interconnected such that the lengths of said third and fourth beams form between them an obtuse angle, said second ends of said third and fourth beams being interconnected with said second ends of said first and second beams, respectively, such that said first, second, third and fourth beams form a rhombus.

3. The optical system of claim 2, wherein said first material extends continuously around said collar, and wherein said first, second, third and fourth arms of each of said actuators are integrally formed as bifurcations of said collar.

4. The optical system of claim 3, wherein said rods are inserted within apertures formed by said bifurcations.

5. The optical system of claim 4, wherein, over an operating range of temperatures including room temperature, each of said rods is oversized for said aperture, such that said actuator is pre-stressed.

6. The optical system of claim 1, wherein said thermally-responsive actuator assembly comprises three of said actuators spaced around said collar.

7. The optical system of claim 1, wherein said first ends of said beams are flexibly interconnected via an attachment configuration configured for attaching said actuator assembly to one of said first and second optical components.

8. The optical system of claim 7, wherein said attachment configuration of each of said actuators is located further from the optical axis than a straight line extending between said second ends of said first and second beams and closer to the optical axis than said second ends of said first and second beams.

9. The optical system of claim 8, wherein said beams are flexibly interconnected via at least one integral hinge, said integral hinge being oriented to define an effective hinge axis lying in a plane substantially perpendicular to the optical axis.

10. The optical system of claim 1, wherein said second coefficient of thermal expansion is greater than said first coefficient of thermal expansion, so that the effective coefficient of thermal expansion of said thermally-responsive actuator is negative.

11. The optical system of claim 2, wherein said thermally-responsive actuator assembly comprises three of said actuators spaced around said collar.

12. The optical system of claim 2, wherein said first ends of said beams are flexibly interconnected via an attachment configuration configured for attaching said actuator assembly to one of said first and second optical components.

13. The optical system of claim 12, wherein said attachment configuration of each of said actuators is located further from the optical axis than a straight line extending between said second ends of said first and second beams and closer to the optical axis than said second ends of said first and second beams.

14. The optical system of claim 13, wherein said beams are flexibly interconnected via at least one integral hinge, said integral hinge being oriented to define an effective hinge axis lying in a plane substantially perpendicular to the optical axis.
